(19) United States
(12) Patent Application Publication
(10) Pub. No.: US 2004/0196594 A1
(43) Pub. Date: Oct. 7, 2004

(54) Flexible media thin-film slider with wear resistant extension

(76) Inventors: Michael F. Dickson, Logan, UT (US); Jeffrey L. Felt, Layton, UT (US); Bart J. Ewer, Sunset, UT (US); David L. Hall, Salt Lake City, UT (US); David C. De Young, Ogden, UT (US); Mark Thornley, Layton, UT (US); R. Matthew Palmer, Pleasant View, UT (US)

Correspondence Address: Everett D. Robinson, Parsons Behle & Latimer, 201 South Main Street, Suite 1800, P.O. Box 45898, Salt Lake City, UT, 84145-0898, US

(21) Appl. No.: 10/744,599

(22) Filed: Dec. 23, 2003

Related U.S. Application Data
(60) Provisional application No. 60/453,714, filed on Dec. 23, 2002.

(51) Int. Cl. G11B 5/60

(52) U.S. Cl. 360/236.5

(57) ABSTRACT

Disclosed herein are storage device sliders incorporatig thin-film sensors and wear resistant extensions. Also disclosed herein are data storage devices and assemblies utilizing those sliders. Detailed information on various example embodiments of the inventions are provided in the Detailed Description below, and the inventions are defined by the appended claims.

### CROSS-REFERENCE TO RELATED APPLICATIONS

This application claims the benefit of U.S. Provisional Application No. 60/453,714 filed Dec. 23, 2002, which is hereby incorporated by reference in its entirety.

### BACKGROUND

The claimed inventions relate generally to disk drives utilizing a flexible medium and more particularly to storage devices utilizing thin film read/write sensors to read and record information on flexible medium, those sensors being incorporated in sliders having wear resistant features.

This application is related to previously filed commonly assigned applications now issued as U.S. Pat. No. 6,115,219, issued 5 Sep. 2000, and U.S. Pat. No. 6,487,049, issued 26 Nov. 2002, which are hereby incorporated by reference.

In a typical storage media drive, a storage media is passed by a drive head such that the drive head can read information from and/or write information to the storage media. Particularly where the storage media is a two-sided disk or other similar object, the information may be stored on both sides thereof. Accordingly, the typical drive includes a pair of opposing drive heads, and the storage media travels between such opposing drive heads. Of course, in the situation where a drive includes multiple media such as multiple disks (usually stacked on a single spindle), each disk travels between its own pair of drive heads.

When the storage media is a disk, to facilitate the reading and/or writing operations of the storage media drive, the storage media is rotated at an angular speed high enough to cause each drive head to ‘ride up’ onto an air bearing formed between the face of the drive head and the surface of the rotating storage media. Under ideal conditions the media is perfectly smooth and rigid, and the air bearing maintains proper separation preventing contact and wear between the heads and the media. Under practical conditions, some contact occurs due to imperfections in the faces of the head structures and the media, imperfections in the planarity of the media and flexure of the media material in operation, particularly if flexible storage media material is used, for example Mylar™.

However, if the storage media is relatively flexible, as can be the case, and should the drive heads become misaligned such that one of the drive sensors becomes unopposed, the flexible storage media will not travel adjacent each drive sensor in close proximity to such drive sensors.

To complicate matters, in a typical drive head, the drive sensor is positioned toward the trailing termination of the air bearing surface on which it resides, and in some instances can even be positioned at such trailing termination. As may be understood, the amount of misalignment that can be tolerated decreases as the drive sensor gets closer to the trailing termination. At the trailing termination, then, practically any misalignment will result in one of the drive sensors being unopposed by an air bearing surface.

### BRIEF SUMMARY

The claimed inventions relate generally to data storage devices utilizing a flexible medium and more particularly to disk drives utilizing thin film read/write sensors to read and record information on flexible medium, those sensors being incorporated in sliders having wear resistant features.

Disclosed herein are storage device sliders incorporating thin-film sensors and wear resistant extensions. Also disclosed herein are data storage devices and assemblies utilizing those sliders. Detailed information on various example embodiments of the inventions are provided in the Detailed Description below, and the inventions are defined by the appended claims.

### BRIEF DESCRIPTION OF THE DRAWINGS

FIG. 1 illustrates a block diagram of an exemplary disk drive.

FIG. 2 depicts a view of an exemplary slider assembly having opposing sensor head structures.

FIG. 3 shows an exemplary slider and sensor head.

FIG. 4 shows an exemplary sensor unit.

FIG. 5a shows a cross-section of an exemplary slider.

FIG. 5b depicts a cross-section of a pair of exemplary sliders in operation with media.

FIGS. 6a and 6b depict a pair of exemplary operational sliders having trailing misalignments.

FIG. 7 depicts an exemplary slider having a wear-resistant extension incorporated into a side-attached closure.

FIG. 8 depicts an exemplary slider having wear-resistant extensions incorporated into a bottom-attached closure.

FIG. 9 shows an exemplary slider having a centered wear-resistant extension incorporated into a readward-attached closure.

FIG. 10 shows an exemplary slider having a pair of wear-resistant extensions incorporated into a pair of readward-attached closures.

FIG. 11 shows an exemplary slider having a pair of wear-resistant extensions incorporated into a closure with an aperture for underside wire access.

FIG. 12 shows an exemplary slider having a closure incorporating a pair of wear-resistant extensions and terminals.

FIG. 13 shows an exemplary slider having a closure incorporating a pair of wear-resistant extensions and a flexible circuit.

FIG. 14 shows an exemplary slider having a terminal extension and a closure incorporating a pair of wear-resistant extensions.

FIGS. 15a and 15b show an exemplary slider construction including a brick incorporating a sensor layer and a body incorporating a pair of wear-resistant extensions.

FIG. 16 shows an exemplary slider having a trailing wear-protective layer incorporating a pair of wear-resistant extensions.

FIG. 17 shows an exemplary slider having a trailing wear-protective laminate incorporating a pair wear-resistant extensions.

Reference will now be made in detail to some disk drive slider products and devices, examples of which are illustrated in the accompanying drawings.

### DETAILED DESCRIPTION

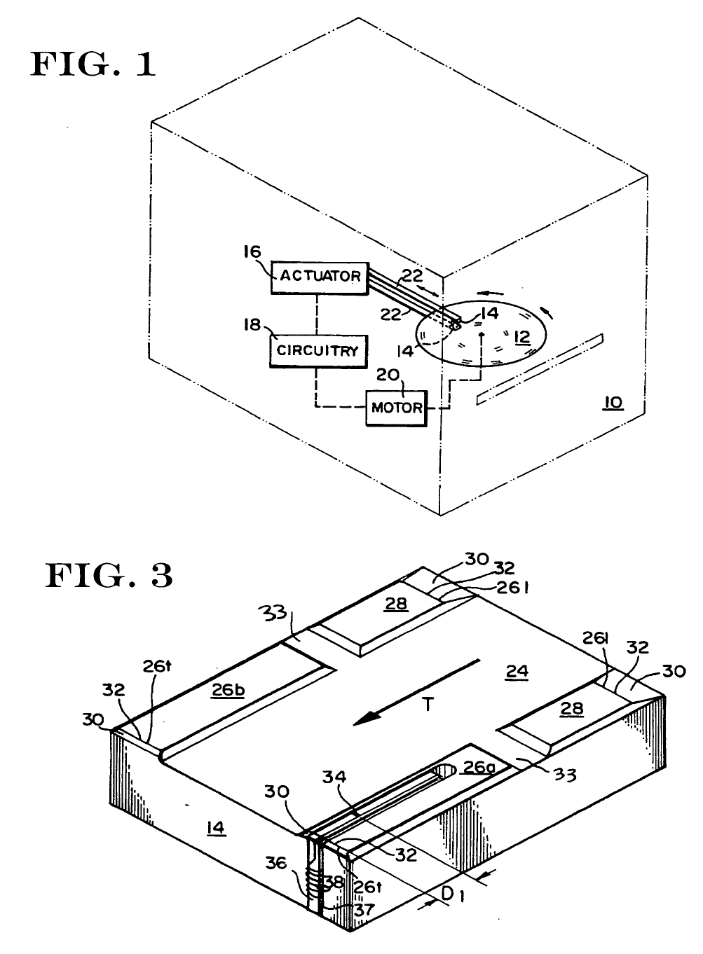

Referring to the drawings in detail wherein like numerals are used to indicate like elements throughout, there is shown in FIG. 1 an exemplary storage media drive 10. The drive 10 is for reading from and/or writing to a storage media 12, as is shown. In this example, the media 12 is a flexible or “floppy” disk or the like, which may be encased within an appropriate cartridge (not shown), and which is removably insertable into the drive 10. Examples of such flexible disk media 12 include known 3.5″ and 5.25″ floppy disks, IOMEGA ZIP™ and PocketZip™ disks, which are manufactured and marketed by IOMEGA Corporation of Roy, Utah, and the like. The media 12 may be constructed of many storage media types, for example a magnetic floppy disk, an optical floppy disk, or even flexible magnetic or optical storage tape. In addition, the media 12 may be fixedly positioned within the drive 10, if so desired.

The drive 10 also includes an appropriate motor 20 to rotate or move the media 12. The motor 20 is typically coaxial with the media 12 and directly drives such media 12 by way of an appropriate spindle interacting with a hub in such media 12. However, the motor may also be non-coaxial and indirectly drive the media 12 by way of gears or the like (not shown). The motor 20 may be any appropriate motor, and is not further described further herein.

As shown in FIG. 1, the drive 10 has a pair of opposing drive heads 14 for reading from and/or writing to the media 12. The opposing drive heads 14 are in intimate relationship with the media 12, with one drive head 14 on either side of such media 12. Each drive head 14 can read from and/or write to an information layer on the respective side of the media 12. The aforementioned intimate relationship is necessary to effectuate the transferring of data between the media 12 and the drive heads 14 as the motor 20 rotates the media 12 past the drive heads 14, especially where individual pieces of such data are organized on the media 12 in exceedingly small spaces.

Despite the need for such intimate relationship, the drive heads 14 are preferably designed to avoid direct contact with the rotating media 12, since such direct contact could wear on and/or damage the drive heads 14 and/or the media 12. However, in many instances, such as where the media 12 is flexible, such direct contact is unavoidable, and is in fact substantially continuous. In such instances, measures are preferably employed to minimize contact friction, or to protect important parts of the head structures from excessive wear.

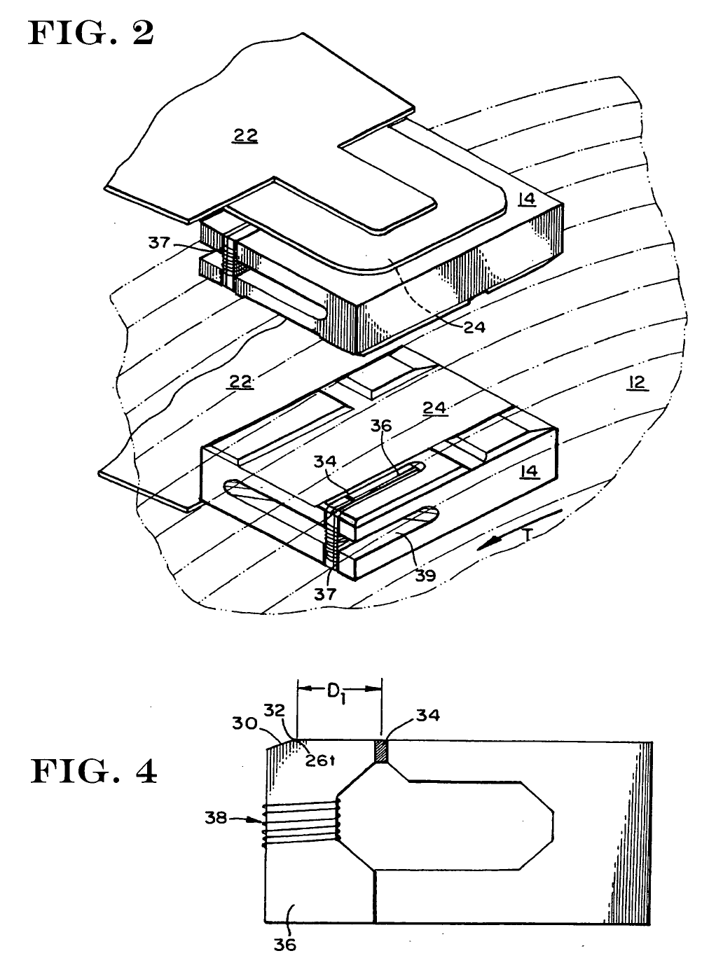

Each drive head 14 is typically supported by a load beam 22, as is seen in FIGS. 1 and 2. Preferably, each drive head 14 is flexibly attached to its respective load beam 22 such that the drive head can orient itself into the aforementioned intimate relationship with the surface of the media 12. In one example, a flexure rotating over a dimple (i.e., a gimbal mount) (not shown) is employed.

In addition to the drive heads 14 and the motor 20, the drive 10 typically has an actuator 16 (FIG. 1) for actuating movement of the drive heads 14 with respect to the media 12. As should be understood, especially with regard to rotating media 12, such actuator 16 positions the drive heads 14 in a radial manner with respect to such media 12 so that the drive heads 14 can read from and/or write to particular radially organized tracks of data (not shown) or to a helical track of data (not shown) on the rotating media 12. The actuator 16 may move the drive heads 14 linearly, either along a radial line of the media 12 or at an angle to such a radial line, or may move the drive heads 14 about a pivot point exterior to the media 12, among other modes of operation. Typically, and as should be understood, the actuator 16 positions the drive heads 14 by way of the load beams 22.

As also seen in FIG. 1, the drive 10 includes appropriate circuitry 18 for facilitating the aforementioned reading and/or writing by the drive heads 14. Such circuitry 18 operates the drive heads 14, actuator 16, and motor 20, and also facilitates transfers of information between the media 12 and a selected external entity (not shown) in response to a request for such information from such external entity, among other things. The external entity is typically a computer or other similar device having a processor and memory.

As should be understood, and especially in the case where the storage media 12 is a disk, the drive 10 may in fact have several disks, typically mounted at different axial heights on a single spindle (not shown). In such a situation, and as is known, each disk typically has its own pair of drive heads 14.

For the purposes of discussion, FIGS. 2 and 3 depict an exemplary slider 14. Slider 14 has a sensor face 24 that faces generally toward the media 12 and also toward the opposing drive head 14 (not shown in FIG. 3). As particularly seen in FIG. 3, the sensor face 24 includes first and second generally parallel longitudinally extending air bearing surfaces 26a, 26b. Each air bearing surface 26a, 26b has a leading termination 261 at one longitudinal end thereof and a generally longitudinally opposing trailing termination 26t at the other longitudinal end thereof. As should be understood, the storage media 12 typically travels adjacent the sensor face 24 of the drive head 14 in a traveling direction T (as shown in FIGS. 2 and 3) that extends generally along the air bearing surfaces 26a, 26b from the respective leading terminations 261 to the respective trailing terminations 26t.

As was alluded to above, in the instance where the media 12 is flexible, actual ‘riding up’ onto an air cushion formed by the air bearing surfaces 26a, 26b is not always established, and direct contact between the drive heads 14 and media 12 may be encountered. Generally, the flexible media 12 does not spin flat, and vibrations caused thereby disrupt the ability to ‘ride up’. Nevertheless, in such instance, the air bearing surfaces 26a, 26b ‘iron out’ the flexible media, and also act to minimize contact friction with such media 12 and drive heads 14.

The particular arrangements of air bearing surfaces 26a, 26b, rails 28, bevels 30 and blends 32 on the sensor face 24 of each drive head 14 need not be strictly adhered to; these features may be varied or even eliminated to form sliders with different characteristics. For example, other types of bevels 30 and blends 32 may be employed, and some bevels 30 and/or blends 32 may even be removed. Moreover, although each rail 28 is shown as being continuous and uninterrupted, one or more interrupting cross-slots 33 may be placed in the raised rails 28. Such interrupting cross-slots can be useful in forming, regulating, and/or maintaining air bearings.

In the examples of FIGS. 2 and 3, each drive head 14 is typically a unitary body machined from a block of material such as a zirconia or the like. In many instances, the drive head 14 is formed at least initially as one of many drive heads 14 organized and machined into a block of material in the form of rows and columns therein. The rows and columns of drive heads 14 are then appropriately separated into individual elements for further processing and finishing operations.

Referring to FIG. 3, a drive sensor 34 is positioned on the first air bearing surface 26a of each sensor face 24 a distance D1 from the trailing termination 26t of such first air bearing surface 26a. As should be understood, such drive sensor 34 is positioned on such first air bearing surface 26a such that the sensor is flush with such air bearing surface 26a and does not significantly disturb the air bearing formed thereby, and such that full advantage is taken of such formed air bearing. Now it is also to be understood that a drive sensor such as 34 may be configured to not only sense, but also write to the media, for example through coil 38. Alternatively, a sense coil and a write coil may be provided, the sense coil generally having a different number of windings than the write coil as understood by those skilled in the art. Such a coil pair may also be considered to be part of a sensor under a commonly understood definition.

Depicted in FIG. 4 is a drive sensor 34 suitable for use with the exemplary sliders of FIGS. 2 and 3. Sensor 34 is a magnetic drive sensor and is in actuality the upper-most portion of a glass gap in an iron core 36 that is positioned within a longitudinally and vertically extending slot 37 (FIGS. 2 and 3) in the drive head 14. As should be understood, such slot 37 extends longitudinally and vertically into the first air bearing surface 26a and also through any trailing bevel 30 and blend 32 adjacent thereto.

Still referring to FIG. 4, iron core 36 includes a winding 38. Data is magnetically written onto a magnetic storage media 12 by flowing current through the winding 38 in a predetermined manner to create magnetic flux in the core 36 and in particular at the gap/drive sensor 34.. Such flux alters the magnetic orientation of magnetic particles on the side of the media 12 adjacent the gap/drive sensor 34 as the media 12 rotates past such gap/drive sensor 34. Correspondingly, written data on the media 12 is magnetically read therefrom by sensing the magnetic orientation of magnetic particles on the side of the media 12 adjacent the gap/drive sensor 34 as the media 12 rotates past such gap/drive sensor 34. In particular, changes in the magnetic orientation of such magnetic particles change the flux present at the gap/drive sensor 34 as the media 12 rotates there-past, and such changes are made to appear as changing voltages at the winding 38.

In more recent magnetic sensors, instead of a core, certain thin film sensors or magneto-resistive sensors are employed. Using those sensors, rather than mounting a distinctly formed core 36 into the drive head 14 and forming the winding 38 by passing a conductor around the core several times, the core 36, the drive sensor 34 thereon, and/or the winding 38 may instead be formed with the drive head 14 by way of deposition technology or another forming technology. In such deposition technology, layers of material are selectively deposited in a pre-determined step-by-step process to build the head 14. Such deposition technology may for example include the use of multiple masks, etching, sputtering of material, other depositions, etc. If deposition technology is in fact employed, slot 37 and/or slot 39 may not be necessary. It should be noted that while the core 36 shown in FIG. 4 is applicable for magnetic-based media 12, other appropriate devices may be necessary for non-magnetic-based media 12, such as optical-based media 12 or the like.

Still referring to FIG. 3, the sensor face 24 typically includes additional elements in conjunction with the first and second air bearing surfaces 26a, 26b. In particular, each air bearing surface 26a, 26b on each sensor face 24 of each drive head 14 is the top surface of a raised rail 28 on such sensor face 24. The bevel 30 extending from the leading termination 261 of each air bearing surface 26a, 26b typically has a very gentle grade. Accordingly, and as should be understood, the leading bevel 30 contributes to the formation of the air bearing effect when the media 12 is rotated past the drive head 14. In particular, the gentle grade of the leading bevel 30 tends to trap or entrain air moved toward the drive head 14 by the rotating media 12, and to insert the trapped air between the air bearing surfaces 26a, 26b and the surface of the media 12. Accordingly, and as should be likewise understood, the trailing bevel 30 quickly dissipates the trapped air and therefore dissipates the air bearing formed thereby.

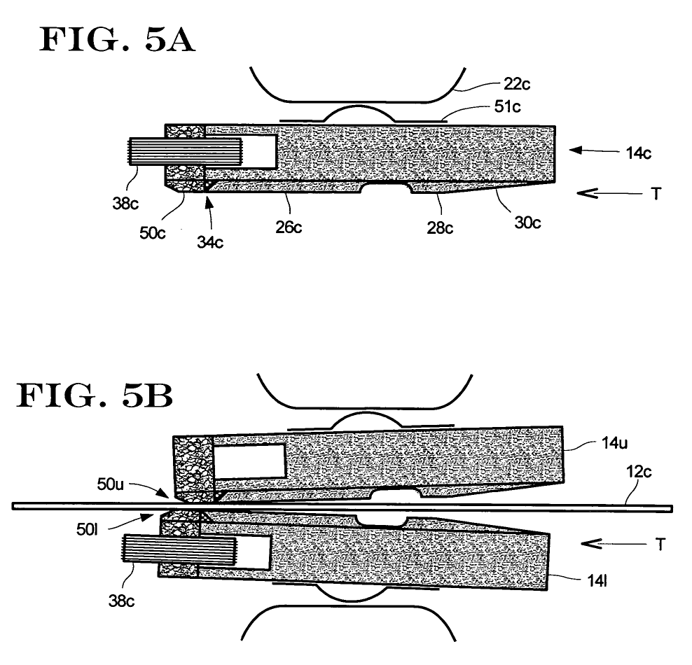

For the purposes of discussion, FIG. 5a depicts in cross-section an exemplary slider 14c, bearing similarity to the slider components shown in FIGS. 2, 3 and 4. Slider 14c is of the type having rails, one shown having a forward rail 28c and a rear rail 26c, the forward rail having bevel 30c for producing an air-bearing. A sensor 34c is provided for reading and writing the surface of proximal media, writing being performed by the energizing of coil 38c and sensing by sampling the voltage therefrom. A trailing edge 50c is a point of transition from high to low air pressure between the slider and proximal media while that media is traveling in the operating direction “T”. Slider 14c is attached to load beam 22c by way of flexure 51c by conventional methods, flexure 51c providing for rotation of slider 14c relative to beam 22c such that the slider may attain proper orientation relative to the media in normal operation.

FIG. 5b depicts in cross-section a slider pair, 14u and 14l, in operational position with media 12c. In this view, for which only one rail is visible, the lower slider 141 contains a coil 38c for reading and writing the media, while opposing upper slider rail does not have a coil (the upper slide rail may contain a coil at the other rail, if reading/writing the upper media surface were desirable). Slider 14u is positioned on the opposite side of media 12c from lower slider 14l to provide pressure against the air bearing formed between media 12c and lower slider 14l, which maintains the read/write sensor in close proximity to the media. Also in this view, upper slider trailing edge 50u does not directly oppose lower slider trailing edge 50l, as the upper slider 14u is positioned slightly forward of lower slider 14l. Such a difference in forward position may be referred to as a trailing misalignment.

Trailing misalignments may occur due to several factors, which make impractical the requirement of maintaining small-tolerance alignments in operation of the storage device. First, a misalignment may occur due to normal manufacturing tolerances in the load beam, or in the attachment of the load beam to the actuating device, and in the position of heads relative to media. Second, because the attachment between the load beam and the slider is flexible, there is a tendency for the slider to move, especially where the media is not perfectly flat or of uniform thickness. Third, if the traveling media has imperfections, or is dirty, one or both of the sliders may drag against the traveling media. Because the load beams cannot be made to be perfectly stiff, the sliders may oscillate in the direction of media travel, which oscillation may be started from that drag or environmental vibration of the storage device itself.

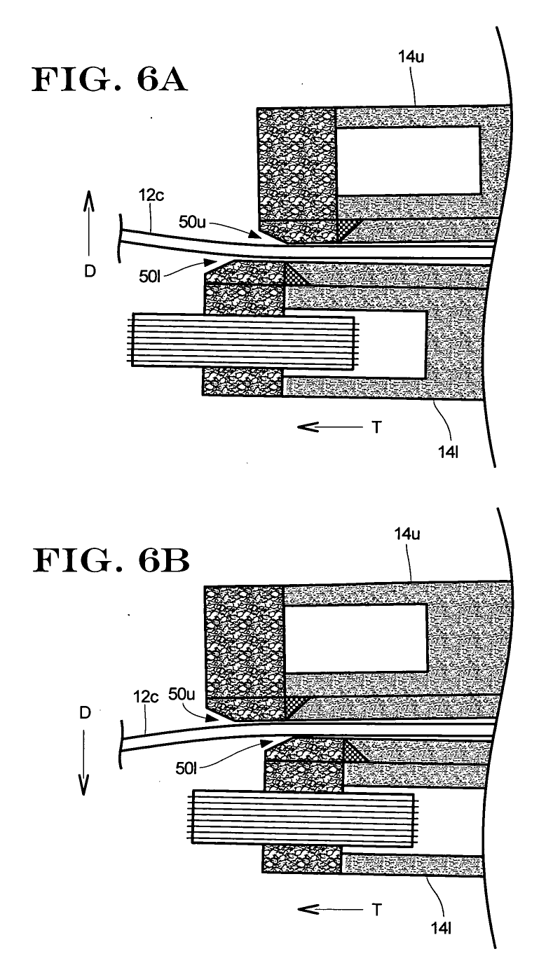

Shown in FIGS. 6a and 6b in cross-section are the rearward portions of a slider pair, 14u and 14l, enclosing media 12c, the sliders being of the type shown in FIG. 5b. In these figures media 12c travels in the direction labeled “T”. In FIG. 6a, the upper slider 14u precedes lower slider 14l, with the upper trailing edge 50u also preceding lower trailing edge 50l. In that position, a high air pressure occurs against the media and the lower slider 14l in the area beginning at the opposite side of media 12c from upper trailing edge 50u and ending at lower trailing edge 50l. The area on the opposite side of media 12c is not supported by slider material, in which a low pressure forms. The combination of high and low pressure on opposing sides of media 12c causes a deflection of the media in the direction marked “D”. Although media 12c is flexible, some degree of rigidity is maintained. The deflection thereby tends to cause the media 12c to be forced against the upper trailing edge 50u. A deflection in the opposite direction may occur if the lower slider precedes the upper slider, as depicted in FIG. 6b.

With current processes, magneto-resistive (Anisotropic Magnetoresistive, Giant Magnetoresistive, and Dual Stripe Magnetoresistive) sensors are typically located within 20-30 μm of the trailing edge of a slider. In a rigid disk application this trailing edge position allows the sensor to remain in close proximity to the media as the slider flies above the media. The rigid media supports the pressure between the slider and the media without significant distortion.

In a floppy disk environment, the media itself is unable to support the pressure between an unopposed slider and the media without significant distortion. This distortion causes separation between the sensor and the magnetic information-containing material, which causes loss of signal. The pressure can be maintained by a separate slider on the opposite side of the media. If a sensor is located on or near the trailing edge of the sliders without further trailing material, it is difficult to maintain support unless the sliders are kept in nearly perfect-alignment. If the sensor is moved some distance away from the trailing edge, or if significant overlap exists between opposing sliders, it is possible for the media to be supported and good spacing (contact) can exist between the sensor and the media.

Flexible media is abrasive and wears material away from the slider. Because of the high pressures and forces acting on the media as it passes between the two sliders, the media tends to exhibit intense oscillations as it exits the trailing edges of the sliders. These oscillations are largely due to spinning disk dynamics which are suppressed to a large extent while the media is between the sliders. When the media escapes the slider enclosure, owing to its continuous nature the media resumes its natural vibrations. In this process, the last bit of media between the heads, and the first bit, may experience excessive oscillating direction movements causing media wrap. These oscillations cause significantly more wear on the trailing edge as compared to the rest of the ABS (air bearing surface). It is therefore desirable to move the sensor away from the trailing edge, which may reduce material loss at the sensor location and thereby improve sensor life.

According to one thin-film process, sensors are deposited on the surface of a wafer. An overcoat of approximately 25 μm is then deposited over the top of the sensors. In this configuration, with magneto-resistive sensors, the sensor is too close to the trailing edge for repeated use in a flexible media environment. It is therefore desirable to move the sensor away from the trailing edge, which may reduce material loss at the sensor location and thereby improve sensor life.

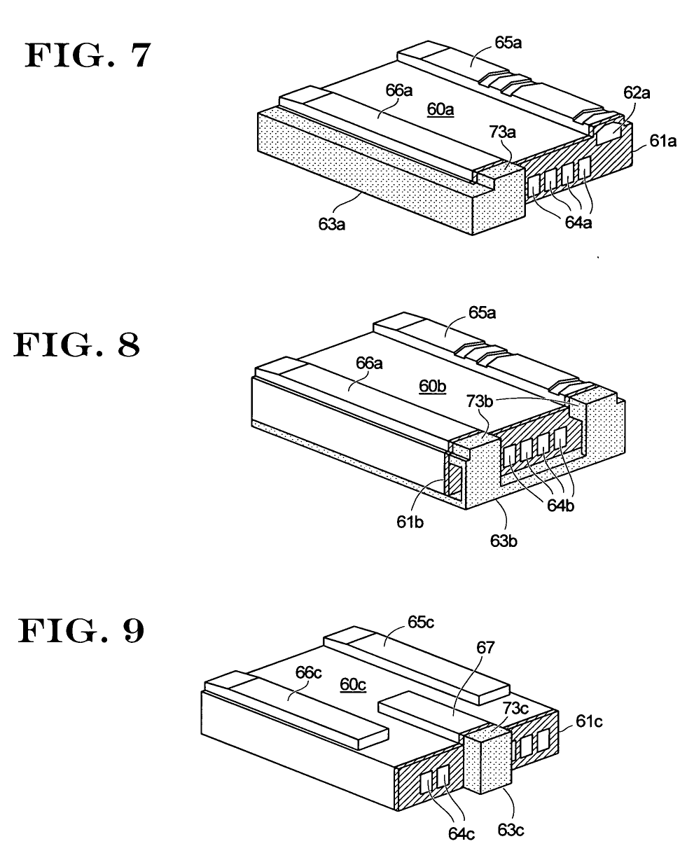

Depicted in FIGS. 7 to 17 are several distinct thin-film slider configurations, which may provide relief from the sensor wear described above, by providing additional material on the trailing edge. Referring first to FIG. 7, an exemplary slider is depicted in perspective having a slider body 60a and a thin film sensor layer 61a. A sensor rail 65a and a supporting rail 66a are optionally formed in the slider body 60a providing localized pressure to bring the sensor 62a, or a sensor of an opposing slider, into position relative to proximal media. In practice, sensor layer 61a may be a lamination of several layers manufactured through a thin-film process as described above, and may include a read/write sensor 62a and terminals 64a for making electrical connection to the sensor. A sensor layer may be directly deposited on a body or body material, or may be formed separately and attached through conventional methods. An overcoat layer is typically applied to slider bodies and sensor layers, which may provide protection from wear and from electrostatic discharge. Of course, the overcoat layer is not applied over terminals 64a, which may be achieved through conventional masking techniques. Terminals 64a may also have plated or deposited thereto a corrosion resistant and electrically conductive material, such as gold, nickel alloy or carbon composite, and may have wires welded or otherwise fastened thereto providing to a connection with read/write circuitry as previously described. Wear-resistant material 63a, otherwise referred to as a closure, is applied to the body/sensor combination; the particular configuration of FIG. 7 being largely attached to one side of the slider body 60a and providing additional supporting material at the trailing edge of the slider at 73a.

Now the configuration of FIG. 7 as shown is not generally sufficient to prevent wear to the sensor 62a, as the closure material does not extend behind the trailing edge of the slider in the sensor area. That configuration, however, may provide media support to an opposing slider and sensor in the event of a misalignment. In order to provide sensor wear protection, closure material may be applied to the opposite side of 60a, particularly trailing the sensor, largely attached to the opposite side of slider body 60a from the attachment of closure material 63a.

Described in FIGS. 8 to 17 are other slider configurations, labeled in similar fashion to the slider depicted in FIG. 7. More particularly, the sliders of FIGS. 8 to 17 may each include a slider body 60, a sensor layer 61, a sensor 62, closure material 63, terminals 64, rails 65 and 66, and closure material 73 providing support and/or wear protection to the sensor of the particular slider configuration, each component individually identified by a suffix “b”, “c”, etc. For the purposes of brevity, these component parts will not be further discussed where the above disclosure in combination with the drawings is sufficient.

In FIG. 8 a slider is depicted with closure material 63b largely attached to the bottom of slider 60b. Closure material includes an extension from the slider-bottom attaching portion to trailing supporting material 73b, thereby forming a unitary closure component. As with other described slider configurations, an aperture is provided in closure material 73b to provide bonding access to terminals 64b for wires, as described above.

FIG. 9 depicts another slider configuration, including a third rail 67 in the center of the top of slider 60c, providing an air bearing over a sensor, not shown, that sensor located to the trailing edge of that third rail 67. In this example, closure material 63c is provided attached to sensor layer 61c at the center of the rear-facing surface thereof, the closure material 63c including a supportive and wear protective area 73c. In that slider configuration, terminals 64c are located to one side or the other (or both) of closure 63c.

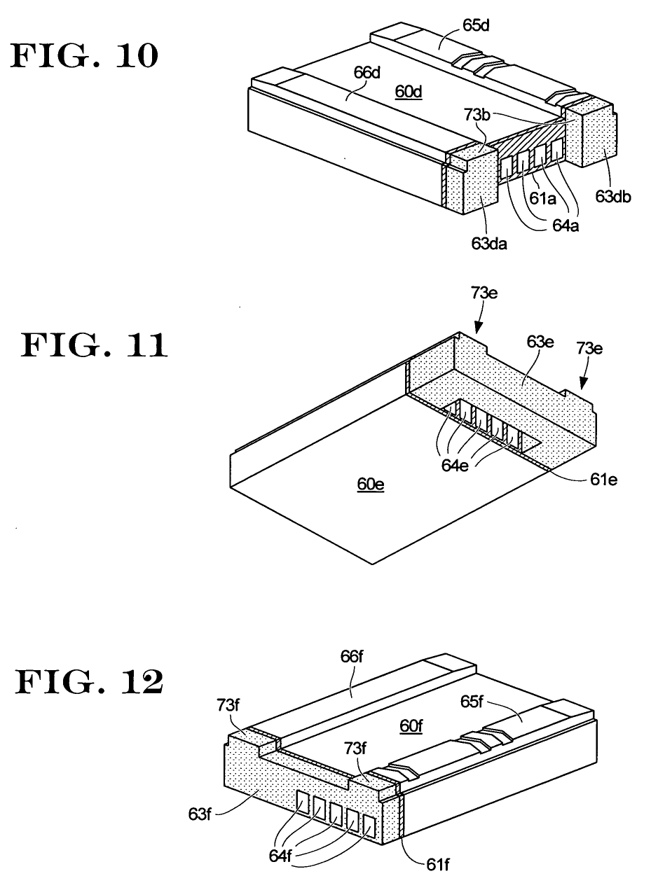

In FIG. 10 a slider is shown having two-part closure material, 63da and 63db, attached to sensor layer 61d at the trailing end of rails 65a and 66a. FIG. 11 shows a similar slider to that of FIG. 10, with closure material 63e attached in the same locations. Additional closure material is added between the material trailing the rails to form a unitary closure material component 63e. Also provided is an aperture in the closure 63e at the bottom of the slider, providing access to terminals 64e.

FIG. 12 depicts another slider configuration having a closure material 63f attached generally to the entire trailing surface of sensor layer 61f. In this configuration terminals 64f are rather provided in the closure material 63f. Those terminals may be included in closure 63f through several methods.

In a first method, closure 63f is first formed with terminal channels and attached to sensor layer 61f. Terminals are then plated through the terminal channels from terminals located in sensor layer 61f to near the surface of closure 63f. Alternately, sputtering or another vapor deposition process may be used to deposit conductive material at the terminal locations. Wires may then be bonded to the formed terminals.

In a third method, terminals 64f are formed separately from closure 63f and inserted thereto. Electrical attachment between terminals 64f and sensor layer 61f may be performed by the use of conductive adhesive, or alternately a welding operation perhaps using a solder powder, paste or similar compound. Many other methods may be used to provide attachment between the terminals and a sensor layer.

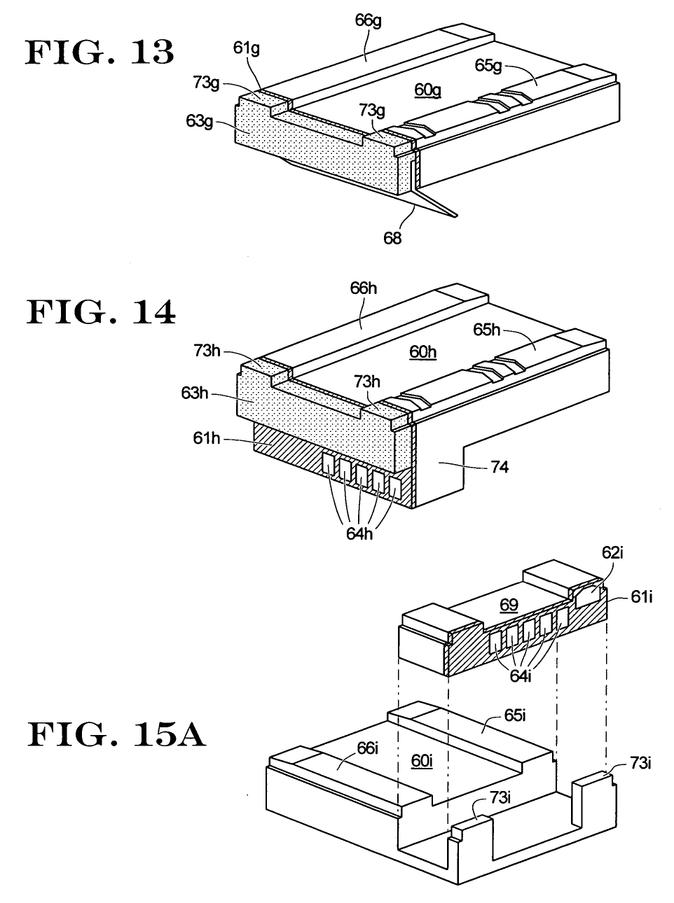

FIG. 13 depicts a slider having a flexible circuit 68 providing electrical access to a sensor located as in the previous examples. Flexible circuit 68 is located adjacent to sensor layer 61g, whereby electrical connections are made, for example by conductive adhesive, between the flexible circuit and the sensor layer contacts. Closure 63g attaches to sensor layer 61g and optionally flexible circuit 68, providing trailing extensions 73g providing support and/or wear protection.

Shown in FIG. 14 is a slider having a slider body extension 74 incorporated in slider body 64h, providing a larger bonding surface for sensor layer 61h. A closure 63h is attached to sensor layer 61h, closure 63h being a similar size to that shown in FIG. 12. Terminals 64h are included in sensor layer 61h in the portion not covered by closure 63h provided by the extension 74. In alternate configurations, the closure may extend up to the entire sensor layer surface, providing more attachment/bonding area. In those configurations, terminals may be provided as in other slider configurations as desired.

The manufacture of closures as disclosed above may be done in many ways. A closure, for example, might be machined from a block of wear-resistant material. Alternatively, a closure might be manufactured utilizing a molding process, or a metal vapor deposition process. Many materials may be selected for closures, as desirable keeping in mind the expected circumstances of use, i.e. the abrasive characteristics of the media, rotational speed and frequency of use and/or motion. In many cases, a closure may be formed from the same material as a slider body, for example altic. Harder minerals, such as corundum, may be used providing enhanced wear resistance. In some circumstances, closures might be gang-machined, i.e. a number of closures machined from a block of material from common machining steps.

Attachment of a closure to a slider body or sensor layer may occur through any number of methods, including soldering, ultrasonic welding, epoxy and many others. The attachment may be performed at any logical stage of slider manufacture, for example at the wafer, bar, or slider stages. If attachment to a sensor layer is to be done, it may be desirable to form grooves, pins or other structures to provide for added adhesion characteristics in either the sensor layer, closure or both.

Now it should be understood that a trailing extension should extend a sufficient distance in the direction of media travel to prevent wear of the sensor (and surrounding material in locality to the sensor) from the media surface. That minimum distance will vary depending on the trailing extension material, the abrasiveness of the media, the rotational speed of the media and the lifespan and service expectations of the slider. For media as used in the IOMEGA ZIP 750 drive, a trailing extension of about 100-125 μm may yield good results. It is also possible to make the trailing extension so long as to cause, at times, the read/write sensor to be located relatively far from the media, particularly if the media has become distorted, as discussed above. Note that that condition may be correctible through repeated read or verify/write operations, relying on the probability that the position and shape of the media will likely change on the next cycle, although it may be desirable to avoid the added time required to perform those operations.

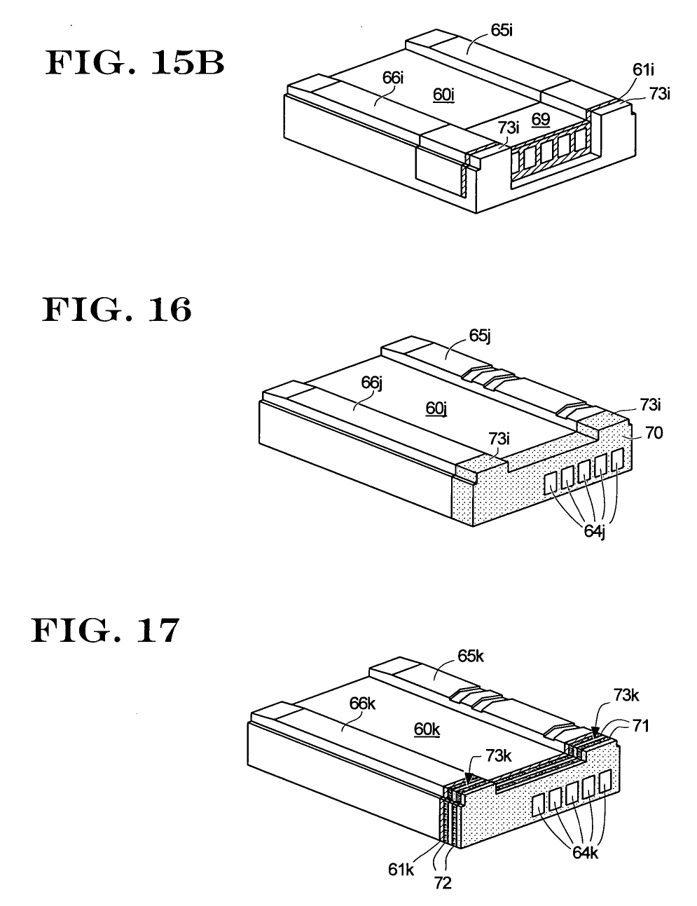

FIGS. 15a and 15b depict an alternate slider configuration in which a “brick” 69 is insertable into a slider body 60i. The sensor layer 61i is attached or deposited to brick 69, which assembly may then be inserted into the slider body 60i as shown in FIG. 15a and bonded thereto, forming the assembly shown in FIG. 15b. Note that in this configuration, trailing extensions 73i are provided in the slider body 60i rather than a closure. A brick 69 might be cut and machined from a wafer whereon sensor layers 61i are formed, without the addition of further material if the slider body 60i is suitably shaped.

Alternate slider configurations may utilize a deposition process to form trailing extensions, for example 73j in FIG. 16. In that example, a relatively thick deposited layer 70 is applied to the sensor layer, not shown, encapsulating that sensor layer thereby. Layer 70 may be any depositable and wear resistant material, for example alumina. Layer 70 may applied in a single step, or alternatively in a series of steps forming a lamination of wear-resistant layer material. In one exemplary method, a protective layer of 105 μm is deposited in a laminate structure of three 35 μm layers. Again, exposed terminals 64j are provided to make electrical connection with an embedded sensor. The terminals may again be built up to the surface of layer 70 from the sensor layer through plating or deposition methods as suggested above.

Now depending on the circumstances of use, a single layer of wear resistant material may be susceptible to breakage and/or separation from the slider structure. Shown in FIG. 17 is a similar slider to that shown in FIG. 16, but rather layers of deposited material onto sensor layer 61k are utilized to provide trailing extensions 73k. In the example of FIG. 16, layers marked 72 are of a relatively stress resistant, soft or flexible material and layers marked 71 are relatively hard and wear resistant material, for example alumina. The laminate structure formed by layers 71 and 72 form a wear resistant layer having trailing extensions but relatively flexible and/or resistant to stress or strain. The deposition of layers 71, 72 and 70 of FIG. 16 may be efficiently performed at the wafer level, particularly before cutting and machining to individual sensor layer components. As in the slider of FIG. 16, the terminals may be built up to the surface of layer 70 from the sensor layer through plating or deposition methods as suggested above.

While storage device sliders incorporating thin-film sensors and wear resistant extensions, slider assemblies and disk drives incorporating those sliders and further the manufacture thereof have been described and illustrated in conjunction with a number of specific configurations and methods, those skilled in the art will appreciate that variations and modifications may be made without departing from the principles herein illustrated, described, and claimed. The claimed products may therefore be embodied in other specific forms without departing from the spirit or essential characteristics of the disclosed products. The configurations described herein are to be considered in all respects as only illustrative, and not restrictive. All changes which come within the meaning and range of equivalency of the claims are to be embraced within their scope.

1. A slider, comprising:
a slider body;
a thin-film sensor layer, said sensor layer including a sensor;
at least one air bearing surface incorporated in said slider body, said surface having a shape suitable for forming a nominal air bearing between said surface and a media surface in proximity to said slider under operating conditions, the operating conditions including the media surface traveling at a particular speed relative to said slider, the operating conditions further including the media being supported by an opposing slider in a position opposite to said slider from the media; and
at least one trailing extension providing wear protection against contact between said sensor included in said sensor layer and the traveling media surface under conditions of trailing misalignment.

2. A slider according to claim 1, further comprising a closure, wherein:
the closure is attached to said slider body; and
the closure includes said at least one trailing extension.

3. A slider according to claim 2, wherein the closure is attached to the side of said slider body.

4. A slider according to claim 2, wherein the closure is attached to the bottom of said slider body.

5. A slider according to claim 1, further comprising a closure, wherein:
the closure is attached to said sensor layer; and
the closure includes said at least one trailing extension.

6. A slider according to claim 5, wherein the slider further comprises a flexible circuit providing electrical connections to the sensor included in said sensor layer.

7. A slider according to claim 5, wherein:
said slider body further comprises an extension providing more surface to which a sensor layer may be attached;
said closure leaves a portion of said sensor layer exposed; and
said sensor layer comprises terminals in the exposed area, said terminals providing electrical connections to the sensor included in said sensor layer.

8. A slider according to claim 1, further comprising a wear protective layer attached to said sensor layer, said wear protective layer further including said at least one trailing extension.

9. A slider according to claim 8, wherein the wear protective layer is formed of a lamination of a plurality of layers of wear-resistant material.

10. A slider according to claim 8, wherein said wear protective layer includes alumina as a wear-resistant material.

11. A slider according to claim 1, further comprising a laminate structure attached to said sensor layer, wherein said laminate structure includes said at least one trailing extension, and further wherein said laminate structure further comprises:
at least one wear protective layer including a relatively hard and wear resistant material; and
at least one other layer including a relatively stress resistant material.

12. A slider according to claim 11, wherein said at least one wear protective layer includes alumina as a wear-resistant material.

13. A slider according to claim 1, wherein said slider body is comprised of an insertable portion and a receptacle portion, further wherein said sensor layer is attached to said insertable portion, further wherein said at least one trailing extension is included in said receptacle portion.

14. A disk drive assembly comprising two slider bodies mounted for the insertion of flexible media therebetween, each slider comprising:
a slider body;
a thin-film sensor layer, said sensor layer including a sensor;
at least one air bearing surface incorporated in said slider body, said surface having a shape suitable for forming a nominal air bearing between said surface and a media surface in proximity to said slider under operating conditions, the operating conditions including the media surface traveling at a particular speed relative to said slider, the operating conditions further including the media being supported by the opposing slider; and
at least one trailing extension providing wear protection against contact between said sensor included in said sensor layer and the traveling media surface under conditions of trailing misalignment.

15. A disk drive assembly according to claim 14, wherein each slider further comprises a closure, and further wherein:
each closure is attached to one or both of a corresponding said slider body and said sensor layer; and
each closure includes said a corresponding at least one trailing extension.

16. A disk drive assembly according to claim 14, wherein each said slider body is comprised of an insertable portion and a receptacle portion, further wherein each of said sensor layers is attached to a corresponding said insertable portion, further wherein each of said at least one trailing extensions is included in a corresponding said receptacle portion.

17. A disk drive assembly according to claim 14, wherein each said slider further comprises a laminate structure attached to said sensor layer, wherein each of said laminate structures includes a corresponding said at least one trailing extension, and further wherein each of said laminate structure further comprises:
at least one wear protective layer including a relatively hard and wear resistant material; and
optionally at least one other layer including a relatively stress resistant material.

18. A disk drive comprising a housing, a motor, an actuator, a receptacle for receiving a storage media disk optionally enclosed in a cartridge, said disk drive further comprising a coupling mechanism for rotating the storage media disk by way of said motor, said disk drive further comprising at least one pair of slider bodies mounted for the insertion of flexible media therebetween, each slider comprising:
a slider body;
a thin-film sensor layer, said sensor layer including a sensor;
at least one air bearing surface incorporated in said slider body, said surface having a shape suitable for forming a nominal air bearing between said surface and a media surface in proximity to said slider under operating conditions, the operating conditions including the media surface traveling at a particular speed relative to said slider, the operating conditions further including the-media being supported by the opposing slider; and
at least one trailing extension providing wear protection against contact between said sensor included in said sensor layer and the traveling media surface under conditions of trailing misalignment.

19. A disk drive according to claim 18, wherein each slider further comprises a closure, and further wherein:
each closure is attached to one or both of a corresponding said slider body and said sensor layer; and
each closure includes said a corresponding at least one trailing extension.

20. A disk drive according to claim 18, wherein each said slider body is comprised of an insertable portion and a receptacle portion, further wherein each of said sensor layers is attached to a corresponding said insertable portion, further wherein each of said at least one trailing extensions is included in a corresponding said receptacle portion.

21. A disk drive according to claim 18, wherein each said slider further comprises a laminate structure attached to said sensor layer, wherein each of said laminate structures includes a corresponding said at least one trailing extension, and further wherein each of said laminate structure further comprises:
at least one wear protective layer including a relatively hard and wear resistant material; and
optionally at least one other layer including a relatively stress resistant material.
